(19) United States
(12) Patent Application Publication
(10) Pub. No.: US 2004/0180771 A1
(43) Pub. Date: Sep. 16, 2004

(54) Method and device for producing envelopes and other enclosed packaging

(75) Inventor: Werner J. Reichstein, Wenden (DE)

Correspondence Address: WILLIAM COLLARD, COLLARD & ROE, P.C., 1077 NORTHERN BOULEVARD, ROSLYN, NY, 11576, US

(73) Assignee: Winkler + Dunnebier Aktiengesellschaft

(21) Appl. No.: 10/797,855

(22) Filed: Mar. 10, 2004

(30) Foreign Application Priority Data
Mar. 13, 2003 (DE) 103 11 431.9

(51) Int. Cl. B41F 1/00

(52) U.S. Cl. 493/320

(57) ABSTRACT

A method and a device for producing envelopes that are imprinted on the inside and/or on the outside, at least in part, and other similar items, including shipping bags of all types. According to the method, an envelope or other item that is imprinted on the inside and/or on the outside, at least in part, is produced by using at least one print unit to imprint a material web and then passing the imprinted web to other stations of an envelope machine, up to the complete production of the envelope.

### CROSS REFERENCE TO RELATED APPLICATIONS

Applicant claims priority under 35 U.S.C. §119 of German Application No. 103 11 431.9 filed Mar. 13, 2003.

### BACKGROUND OF THE INVENTION

1. Field of the Invention

The present invention relates to a method and a device for producing envelopes that are imprinted on the inside and/or on the outside, at least in part, and other similar items, including shipping bags of all types.

2. The Prior Art

Methods and devices for imprinting envelopes and other similar items are known and have the necessary machine components so that a material web is imprinted by at least one printing unit and can then be passed to other stations of an envelope machine for the complete production of the envelopes. It is particularly problematic to assign text or other print images on the inside and/or the outside of other parts of an envelope with accurate fit, if the machine speed must be reduced after an adjustment has been made, for some reason, or if a roller replacement occurs, because a material web has been finished and must be replaced with a new material web. As a result, parts of the imprinted text and/or the printed image regularly are no longer located at the place on the finished product provided for the text or image. The changes take place not only because of web tension changes in the roll changer, but particularly also during the replacement process, as the result of down and up adjustments in the subsequent printing station, as well as due to the printing process itself, which is fundamentally connected with the introduction of moisture into the material web.

The subsequent drying process also changes the material web, once again, whereby the stated influences are also dependent on speed, in part. The problem then becomes visible because the position of the printed image shifts relative to the position of the cutting tool, and therefore the quality of the printed envelopes is no longer perfect.

### SUMMARY OF THE INVENTION

Therefore, it is an object of the present invention to provide measures that allow the machine to control the register or registration automatically.

These and other objects are accomplished, according to the invention, by stretching the printed material web, if needed. Stretching means that the web is drawn in length, i.e. stretched so that predetermined locations are, once again, precisely in the predetermined position.

The length equalization that is necessary in the case of a correction takes place, during processing, as the result of the stretchability of the material web, whereby the material web, i.e. the piece of the material web to be stretched, is firmly clamped in place at a front end and a back end. Because the correction is performed automatically, it is possible to minimize waste and avoid complicated resetting procedures on the machine.

In a further embodiment, the material web is provided with print marks at the same time that it is being imprinted. The location of the print marks on the material web is detected by at least one sensor and the material web is drawn by a pair of tension rollers that can be regulated by control signals of the sensor. Using the control signals, the speed of rotation, i.e. the angular velocity of the pair of tension rollers is regulated so that the material web is given an additional tensile stress, which results in stretching for the recognized registration equalization.

The achievable length change can lie in a magnitude of 0.5 mm or more, for example, and have the result that a text or another printed image is given a location relative to the edges and folds, i.e. fold lines of the envelope, that is precisely coordinated with the register.

The device for implementing the method provides that the required print marks are produced using the print unit, and that at least one sensor for detecting the print marks and a pair of tension rollers having tension rollers that can be regulated are provided, so that the material web is not only transported through the machine but also, at the same time, stretched for a registration correction that has been recognized.

The current position of the text or printed image is scanned with the sensor, using the print mark, and compared with a reference position of a cutting tool that was previously set automatically. If a difference exists between the position of the tool and the current position, the speed of rotation/angular velocity of the pair of tension rollers or the location of the cutting tool are corrected accordingly, so that the text and/or the printed image and the desired cutting position or a different defined tool engagement position agree once again. Finally, the decisive factor is that both the method and the device can be used for an envelope machine, whereby both the type of the sensors used and the reference position in the machine that processes the material web can be freely selected.

### BRIEF DESCRIPTION OF THE DRAWING

Other objects and features of the present invention will become apparent from the following detailed description considered in connection with the accompanying drawing. It should be understood, however, that the drawing is designed for the purpose of illustration only and not as a definition of the limits of the invention.

In the drawing,

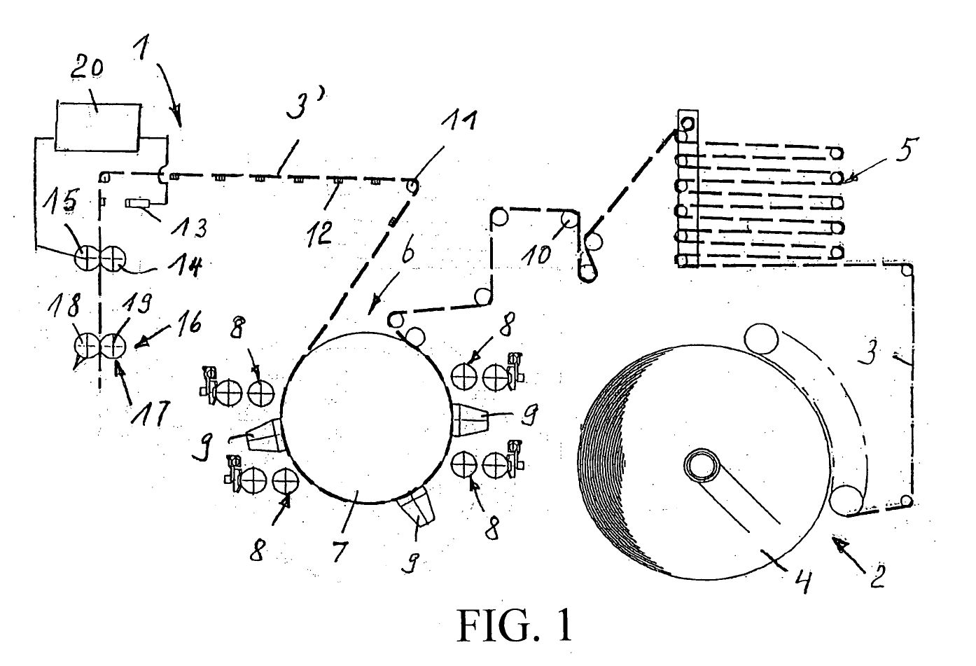

The sole figure, FIG. 1, shows a device for producing envelopes or other packaging in accordance with an embodiment of the invention.

### DETAILED DESCRIPTION OF PREFERRED EMBODIMENTS

FIG. 1 shows a device 1 for producing shipping bags, small or large envelopes, and the like. For simplicity purposes, the term “envelope” will be used herein to refer to all such closable packaging. Device 1 includes a roll-off station 2 having a material web 3 on a supply roll 4. Device 1 also includes a web storage unit 5, and a printing station 6 for imprinting the material web 3. According to the exemplary embodiment, printing station 6 has a central cylinder 7 and several print units 8 and drying devices 9 for drying material web 3.

According to the exemplary embodiment, four print units 8 and three drying devices 9 are provided. Up to the last print unit 8 in the direction of movement of material web 3, a drying device 9 is therefore present behind each print unit 8, in each instance.

Further, deflection rollers 10 and 11 are arranged before and after printing station 6, in order to guide material web 3 in the desired manner.

Using at least one of the print units 8, print marks 12 are also applied to material web 3, at the same time. The location of print marks 12 is precisely positioned relative to the text and/or the printed image that can be produced using print units 8.

Furthermore, according to the exemplary embodiment shown in FIG. 1, a sensor 13 is provided for detecting and determining the location of print marks 12, and serves to control a pair of tension rollers having two tension rollers 14, 15, which is arranged downstream from the sensor.

As soon as print marks 12 on material web 3 are detected by sensor 13 and it is recognized, in this connection, that print marks 12 are not located precisely at the predetermined location, the tensile force, i.e. the speed of rotation, i.e. the angular velocity of the two tension rollers 14 and 15 is changed so that targeted stretching of material web 3 takes place. After the location of print marks 12 has been corrected, registration or register equalization results with regard to the text and the other printed image. This registration equalization can be achieved using the printing station, with reference to another reference location 16. This other reference location 16 can be, for example, a cutting device 17, which has a cutting blade shown symbolically in FIG. 1 on a cutting roller 18, and a counter roller 19.

The pair of tension rollers having the two tension rollers 14 and 15 pulls or stretches the length of a material web piece 3′ to the necessary extent, between the pair of tension rollers and central cylinder 7, and thereby stretches it so that the desired location of marks 12 and therefore of the text and/or of the printed image is achieved.

Finally, it is understood that a suitable electric/electronic control device (hardware) to control a drive motor for tension rollers 14 and 15 on the basis of the sensor data of sensor 13 should also be provided. Basically, the same thing applies for controlling the drive of central cylinder 7, but this control device will not be explained in detail here.

The same is also basically true for all the other stations and machine components of the envelope machine, which are neither shown in the drawing nor described in greater detail, since these parts are not the object of the invention.

What is pertinent is that a necessary registration correction takes place by means of stretching material web piece 3′ between central cylinder 7 and tension rollers 14, 15, and that this correction is achieved fully automatically, using a suitable software, an additionally provided sensor 13, the use of print marks 12, and of precisely controllable tension rollers 14, 15.

Material web piece 3′ between tension rollers 14 and 15, on the one hand, and central cylinder 7 of printing station 6, on the other hand, provided for the registration correction, is not absolutely dry, as the result of the printing process, but rather is damp, to a certain degree. The printing process is fundamentally connected with an introduction of moisture into material web 3. In the exemplary embodiment, devices 9 for drying are not assigned to all print units 8. Material web 3 therefore leaves printing station 6 in a state in which it is damp from printing. This state of being damp from printing facilitates the register correction by means of targeted stretching of material web 3, i.e. at material web piece 3′.

Although only at least one embodiment of the present invention has been shown and described, it is to be understood that many changes and modifications may be made thereunto without departing from the spirit and scope of the invention as defined in the appended claims.

What is claimed is:

1. A method for producing an envelope imprinted at least in part on an inside or outside portion of the envelope comprising the steps of:
(a) imprinting on a material web by at least one print unit to form an imprinted material web;
(b) stretching the imprinted material web to correct registration inaccuracy; and
(c) passing the imprinted material web to other stations of an envelope machine for producing the envelope.

2. The method according to claim 1, further comprising the steps of:
(a) providing the material web with print marks when the material web is being imprinted;
(b) detecting the location of the print marks on the material web with at least one sensor; and
(c) subsequently drawing a portion of the material web by a pair of tension rollers having a speed of rotation/angular velocity regulated using control signals of said at least one sensor to impart an additional tensile stress to the material web portion to cause stretching of the material web portion for any registration equalization that might be necessary.

3. A device for producing an envelope imprinted at least in part on an inside or outside portion of the envelope comprising:
(a) at least one print unit for imprinting on a material web to form an imprinted material web having print marks at a selected location;
(b) at least one sensor for detecting the location of the print marks; and
(c) a pair of controllable tension rollers for stretching the material web for tension and for any necessary registration equalization.

4. The device according to claim 3, further comprising a cutting device having a cutting blade at a reference location.

5. The device according to claim 3, further comprising a printing station having a central cylinder, said at least one sensor being arranged between said central cylinder and said pair of tension rollers.

6. The device according to claim 3, wherein said pair of tension rollers is arranged downstream from said at least one sensor.

7. The device according to claim 5, wherein said pair of tension rollers define a first end point of a material web piece that serves as a stretchable material web and said printing station defines a second end point of the material web piece.
